(19) United States
(12) Patent Application Publication
(10) Pub. No.: US 2015/0056078 A1
(43) Pub. Date: Feb. 26, 2015

(54) PITCH BEARING ASSEMBLY WITH STIFFENER

(71) Applicant: General Electric Company, Schenectady, NY (US)

(72) Inventor: Dhanesh Chandrashekar Pathuvoth, Bengaluru (IN)

(73) Assignee: General Electric Company, Schenectady, NY (US)

(21) Appl. No.: 13/973,076

(22) Filed: Aug. 22, 2013

(51) Int. Cl. F03D 11/00; F16C 33/58; F16C 19/06

(52) U.S. Cl. CPC F03D 11/0008; F16C 19/06; F16C 33/583
USPC 416/131; 384/499

(57) ABSTRACT

A pitch bearing assembly for a wind turbine including a stiffener is disclosed. The pitch bearing assembly includes an outer race and an inner race rotatable relative to the outer race. The inner race may define an inner circumference and may include a plurality of gear teeth around the inner circumference. Further, the pitch bearing assembly includes a stiffener having a body and at least one gear pinion configured with the body. The body extends at least partially around the inner circumference of the inner race and the at least one gear pinion engages a portion of the plurality of gear teeth. Further, the body remains fixed relative to the inner race while the gear pinions may freely rotate along with the inner race.

### FIELD OF THE INVENTION

The present subject matter relates generally to wind turbines and, more particularly, to a pitch bearing assembly having a stiffener.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known airfoil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

To ensure that wind power remains a viable energy source, efforts have been made to increase energy outputs by modifying the size and capacity of wind turbines. One such modification has been to increase the length of the rotor blades. However, as is generally understood, the loading on a rotor blade is a function of blade length, along with wind speed and turbine operating states. Thus, longer rotor blades may be subject to increased loading, particularly when a wind turbine is operating in high-speed wind conditions.

During the operation of a wind turbine, the loads acting on a rotor blade are transmitted through the blade and into the blade root. Thereafter, the loads are transmitted through a pitch bearing disposed at the interface between the rotor blade and the wind turbine hub. Typically, the hub has a much higher stiffness than the rotor blades. Thus, due to the stiffness differential between the hub and the rotor blades, the pitch bearings are often subjected to extreme, varying and/or opposing loads. For example, the inner race of each pitch bearing (i.e., the portion coupled to the rotor blades) may be subjected to varying, localized loads resulting from flapwise or edgewise bending of the rotor blades, whereas the outer race of each pitch bearing (i.e., the portion coupled to the hub) may be subjected to lower and/or differing loads. Such a variation in loading across the inner and outer races can result in substantial damage and/or deformation (e.g. ovalization) to the pitch bearings.

Accordingly, a pitch bearing assembly having a stiffener configured to distribute loads and, thus, to reduce the localized stress within the pitch bearing would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a pitch bearing assembly for a wind turbine. The pitch bearing assembly may include an outer race and an inner race rotatable relative to the outer race. The inner race may define an inner circumference and may include a plurality of gear teeth around the inner circumference. Further, the pitch bearing assembly includes a stiffener having a body and at least one gear pinion. The body extends at least partially around the inner circumference of the inner race and the at least one gear pinion engages a portion of the plurality of gear teeth.

In another aspect, the present subject matter is directed to a pitch bearing assembly for a wind turbine. The pitch bearing assembly may include an outer race and an inner race rotatable relative to the outer race. The inner race may define an inner circumference. Further, the inner circumference may define a volume within the inner race. The inner race may also include a plurality of gear teeth around the inner circumference. Further, the pitch bearing assembly includes a stiffener disposed within the volume. The stiffener includes a fixed portion and a rotatable portion, the fixed portion configured to attach to the hub, the rotatable portion configured to accommodate rotation of the inner race.

In a further aspect, the present subject matter is directed to a rotor blade assembly for a wind turbine. The rotor blade assembly may include a rotor blade having a body shell extending between a blade root and a blade tip. The rotor blade assembly may also include a pitch bearing coupled to the blade root. The pitch bearing may include an outer race and an inner race rotatable relative to the outer race. The inner race defines an inner circumference and includes a plurality of gear teeth around the inner circumference. The rotor blade assembly also includes a stiffener having a body and at least one gear pinion engaged with the body. The body extends at least partially around the inner circumference and the at least one gear pinion engages a portion of the plurality of gear teeth. Additionally, the rotor blade is configured to be coupled to the pitch bearing and the pitch bearing is configured to be coupled to a hub of the wind turbine.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine;

FIG. 2 illustrates a perspective view of one of the rotor blades of the wind turbine shown in FIG. 1;

FIG. 3 illustrates a cross-sectional view of one embodiment of a pitch bearing assembly in accordance with aspects of the present subject matter;

FIG. 4 illustrates a close-up, cross-sectional view of a portion of the pitch bearing assembly as shown in FIG. 3;

FIG. 5 illustrates a perspective view of a pitch bearing assembly according to the present disclosure, particularly illustrating the stiffener exploded away from the pitch bearing;

FIG. 6 illustrates a top view of the pitch bearing assembly as viewed from inside the hub in accordance with aspects of the present subject matter;

FIG. 7 illustrates a top view of another embodiment of the pitch bearing assembly as viewed from outside the hub in accordance with aspects of the present subject matter;

FIG. 8 illustrates a perspective view of the pitch bearing assembly as viewed from inside the hub in accordance with aspects of the present subject matter; and,

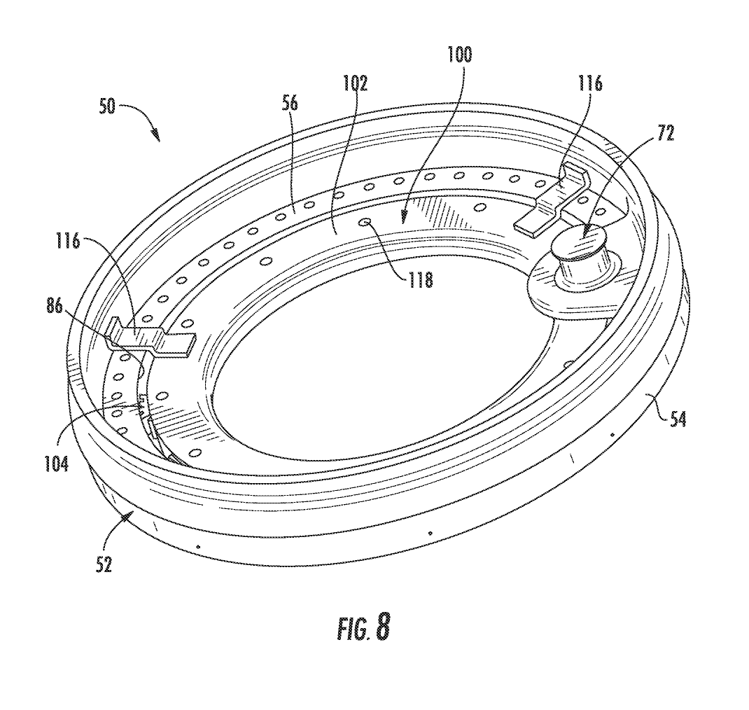

FIG. 9 illustrates another embodiment of the pitch bearing assembly in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a pitch bearing assembly for a wind turbine having a stiffener configured to resist deformation of the pitch bearing under a load. More specifically, the pitch bearing assembly may include an outer race and an inner race rotatable relative to the outer race. The inner race defines an inner circumference and includes a plurality of gear teeth around the inner circumference. The stiffener includes a fixed portion and a rotatable portion. The fixed portion is configured to attach to the hub, whereas the rotatable portion is configured to accommodate rotation of the inner race. For example, in one embodiment, the fixed portion of the stiffener corresponds to an annular body affixed to the hub via one or more mounting supports. In another embodiment, the rotatable portion corresponds to a plurality of gear pinions configured to engage the plurality of gear teeth around the inner circumference of the inner race. Such a configuration allows the gear pinions to rotate along with the pitch bearing when the inner race rotates to pitch the corresponding rotor blade. As such, if the pitch bearing deforms under a load, the gear pinions are capable of resisting the deformation. Accordingly, the loads transmitted through the rotor blade and into the pitch bearing may be more evenly distributed, thereby protecting the pitch bearing from uneven or excessive loads which may result in bearing failure.

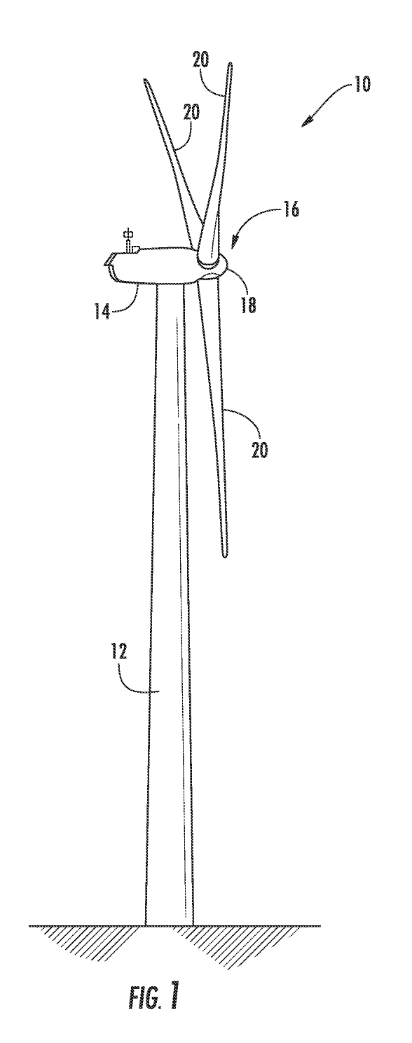

Referring now to the drawings, FIG. 1 illustrates a side view of one embodiment of a wind turbine 10. As shown, the wind turbine 10 generally includes a tower 12, a nacelle 14 mounted on the tower 12, and a rotor 16 coupled to the nacelle 14. The rotor 16 includes a rotatable hub 18 and at least one rotor blade 20 coupled to and extending outwardly from the hub 18. For example, in the illustrated embodiment, the rotor 16 includes three rotor blades 20. However, in an alternative embodiment, the rotor 16 may include more or less than three rotor blades 20. Each rotor blade 20 may be spaced about the hub 18 to facilitate rotating the rotor 16 to enable kinetic energy to be transferred from the wind into usable mechanical energy, and subsequently, electrical energy. For instance, the hub 18 may be rotatably coupled to an electric generator (not shown) positioned within the nacelle 14 to permit electrical energy to be produced.

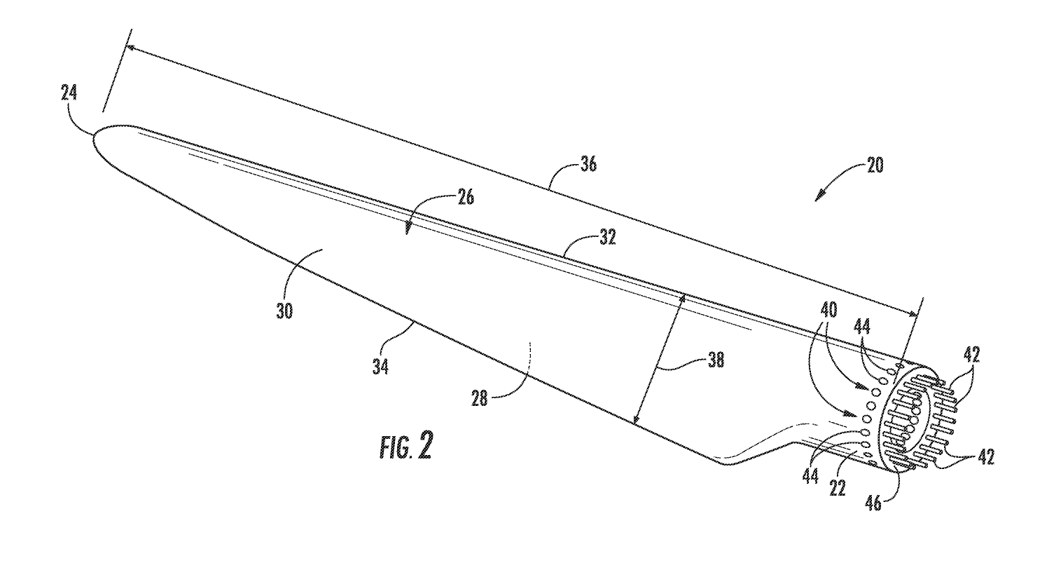

Referring now to FIG. 2, a perspective view of one of the rotor blades 20 shown in FIG. 1 is illustrated in accordance with aspects of the present subject matter. As shown, the rotor blade 20 includes a blade root 22 configured for mounting the rotor blade 20 to the hub 18 of a wind turbine 10 (FIG. 1) and a blade tip 24 disposed opposite the blade root 22. A body shell 26 of the rotor blade 20 may extend lengthwise between the blade root 22 and the blade tip 24 and may generally serve as the outer shell of the rotor blade 20. As is generally understood, the body shell 26 may define an aerodynamic profile (e.g., by defining an airfoil shaped cross-section, such as a symmetrical or cambered airfoil-shaped cross-section) to enable the rotor blade 20 to capture kinetic energy from the wind using known aerodynamic principles. Thus, the body shell 26 may generally include a pressure side 28 and a suction side 30 extending between a leading edge 32 and a trailing edge 34. Additionally, the rotor blade 20 may have a span 36 defining the total length of the body shell 26 between the blade root 22 and the blade tip 24 and a chord 38 defining the total length of the body shell 26 between the leading edge 32 and the trailing edge 34. As is generally understood, the chord 38 may vary in length with respect to the span 36 as the body shell 26 extends from the blade root 22 to the blade tip 24.

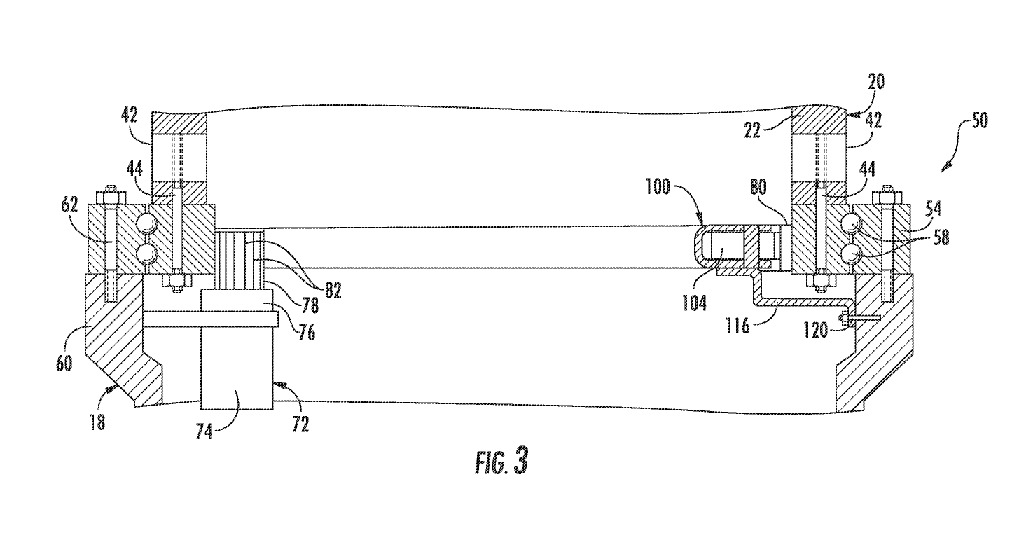

Moreover, as shown, the rotor blade 20 may also include a plurality of T-bolts or root attachment assemblies 40 for coupling the blade root 20 to the hub 18 of the wind turbine 10. In general, each root attachment assembly 40 may include a barrel nut 42 mounted within a portion of the blade root 22 and a root bolt 44 coupled to and extending from the barrel nut 42 so as to project outwardly from a root end 46 of the blade root 22. By projecting outwardly from the root end 46, the root bolts 44 may generally be used to couple the blade root 22 to the hub 18 (e.g., via a pitch bearing 52 (FIG. 3)), as will be described in greater detail below.

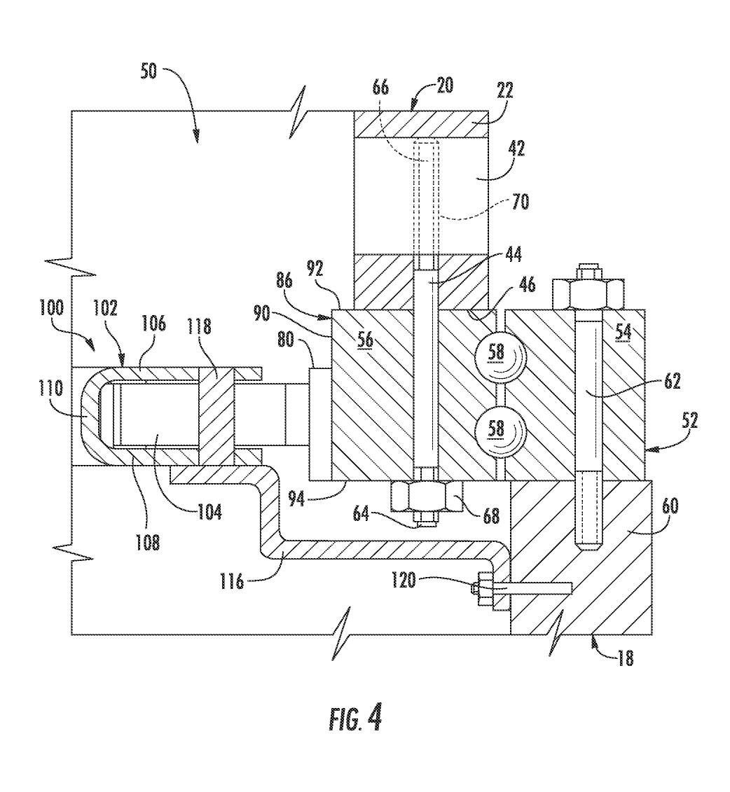

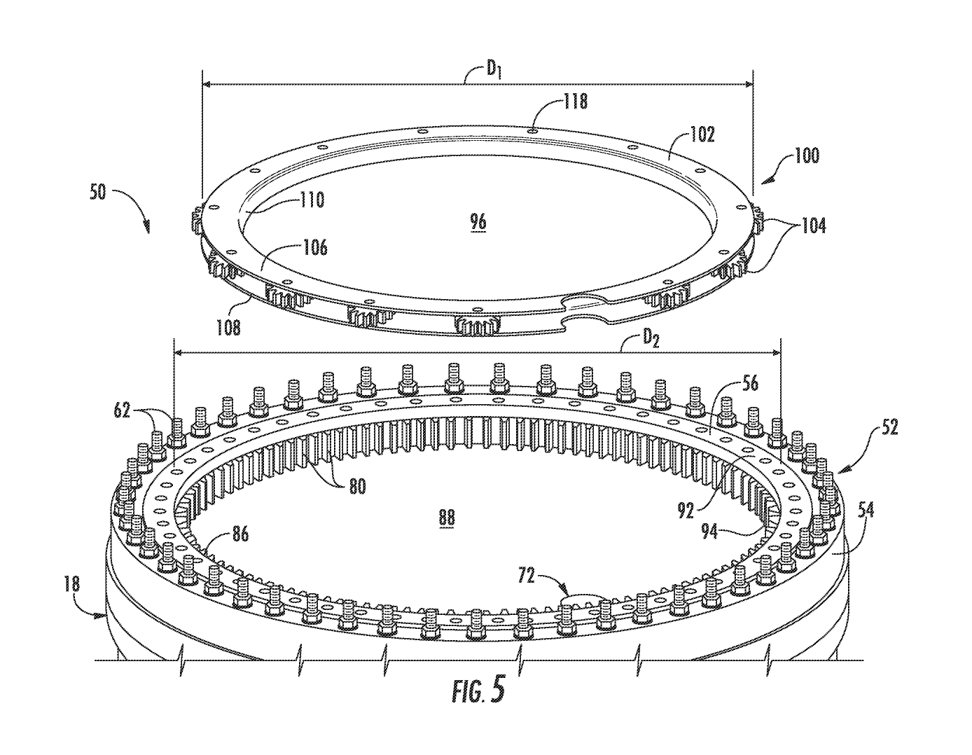

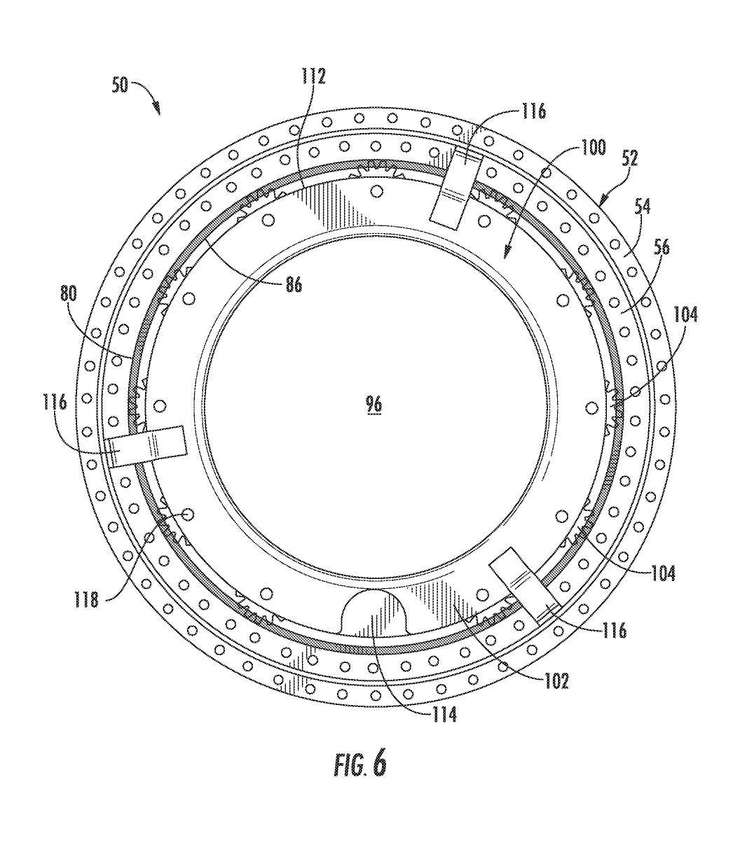

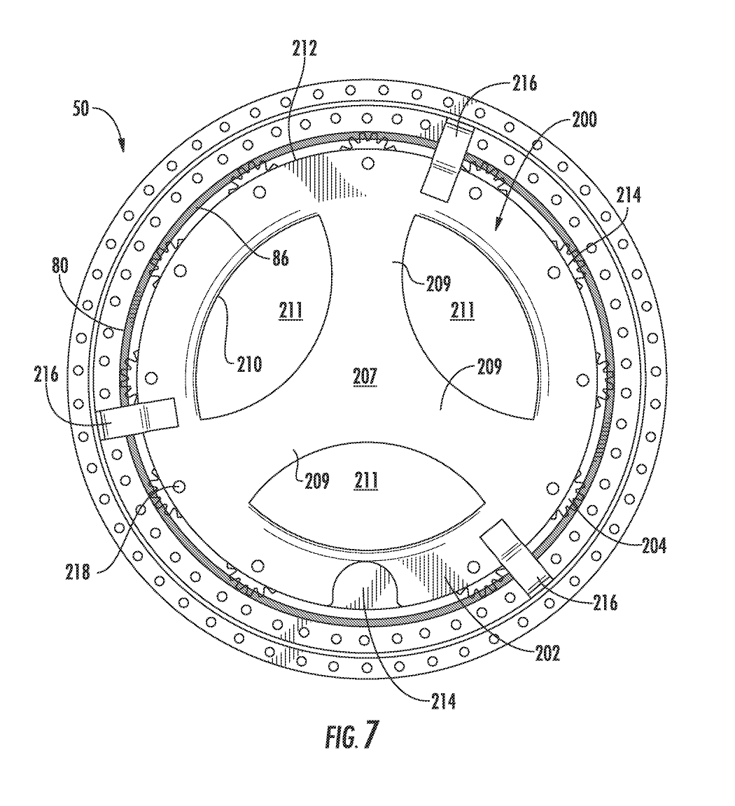

Referring now to FIGS. 3-7, several views of a pitch bearing assembly 50 suitable for mounting a rotor blade 20 to the hub 18 of a wind turbine 10 is illustrated in accordance with aspects of the present subject matter. Specifically, FIG. 3 illustrates a partial, cross-sectional view of the rotor blade 20 shown in FIG. 2 mounted onto the hub 18 via the pitch bearing assembly 50. FIG. 4 illustrates a close-up, cross-sectional view of a portion of the pitch bearing assembly 50 as shown in FIG. 3. Additionally, FIG. 5 illustrates a perspective view of the pitch bearing assembly 50 as shown in FIG. 3, particularly illustrating a pitch bearing stiffener 100 exploded away from a pitch bearing 52. FIG. 6 illustrates a top view of the pitch bearing assembly 50 as viewed from inside the hub 18 and FIG. 7 illustrates a perspective view of the pitch bearing assembly 50 as viewed from inside the hub 18.

As depicted, the pitch bearing 52 may include an outer bearing race 54, an inner bearing race 56, and a plurality of roller elements (e.g., balls 58) disposed between the outer and inner races 54, 56. The outer race 54 may generally be configured to be mounted to a hub flange 60 of the hub 18 using a plurality of hub bolts 62 and/or other suitable fastening mechanisms. Similarly, the inner race 56 may be configured to be mounted to the blade root 22 using the root bolts 44 of the root attachment assemblies 40. For example, as particularly shown in FIG. 4, each root bolt 44 may extend between a first end 64 and a second end 66. The first end 64 of each root bolt 44 may be configured to be coupled to a portion of the inner race 56, such as by coupling the first end 64 to the inner bearing race 56 using an attachment nut 68 and/or other suitable fastening mechanism. The second end 66 of each root bolt 44 may be configured to be coupled to the blade root 22 via the barrel nut 42 of each root attachment assembly 40. Specifically, the second end 66 of each root bolt 44 may extend into and may be secured within an axially extending, threaded opening 70 defined through at least a portion of each barrel nut 42. Alternatively, the second end 66 of each root bolt 44 may simply extend into the blade root 22 and the barrel nut 42 may be absent.

As is generally understood, the inner race 56 may be configured to rotate relative to the outer race 54 (via the roller elements 58) to allow the pitch angle of each rotor blade 20 to be adjusted. As shown in FIG. 3, such relative rotation of the outer and inner races 54, 56 may be achieved using a pitch adjustment mechanism 72 mounted within a portion of the hub 18. In general, the pitch adjustment mechanism 72 may include any suitable components and may have any suitable configuration that allows the mechanism 72 to function as described herein. For example, as shown in the illustrated embodiment, the pitch adjustment mechanism 72 may include a pitch drive motor 74 (e.g., an electric motor), a pitch drive gearbox 76, and a pitch drive pinion 78. In such an embodiment, the pitch drive motor 74 may be coupled to the pitch drive gearbox 76 so that the motor 74 imparts mechanical force to the gearbox 76. Similarly, the gearbox 76 may be coupled to the pitch drive pinion 78 for rotation therewith. The pinion 78 may, in turn, be in rotational engagement with the inner race 56. For example, as shown in FIG. 3, a plurality of gear teeth 80 are formed along the inner circumference 86 of the inner race 56, with the gear teeth 80 being configured to mesh with corresponding pinion gear teeth 82 formed on the pinion 78. Thus, due to meshing of the gear teeth 80, 82, rotation of the pitch drive pinion 78 results in rotation of the inner race 56 relative to the outer race 54 and, thus, rotation of the rotor blade 20 relative to the hub 18.

Referring to FIG. 4, the inner race 56 may define a top surface 92, a bottom surface 94, and an inner surface 90 extending perpendicularly between the top and bottom surfaces 92, 94. The inner surface 90 may generally define the inner circumference 86 of the inner race 56. Further, as particularly shown in FIG. 5, the inner circumference 86 may define an open volume 88 within the inner race 56 that extends between the horizontal planes defined by the top and bottom surface 92, 94 of the inner race 56. Additionally, as indicated above, a plurality of gear teeth 80 may be defined around the inner circumference 86 of the inner race 56. Moreover, as shown in the illustrated embodiment, the gear teeth 80 may be configured to extend height-wise along the inner circumference 86 only partially between the top and bottom surfaces 92, 94 of the inner race 56. Alternatively, the gear teeth 80 may be configured to extend height-wise fully between the top and bottom surfaces 92, 94.

As mentioned, the pitch bearing assembly 50 as described herein includes a stiffener 100. Referring particularly to FIGS. 4 and 5, the stiffener 100 includes a fixed portion 102 and a rotatable portion 104. As mentioned, the fixed portion 102 is configured to attach to the hub, whereas the rotatable portion 104 is configured to accommodate rotation of the inner race. In the illustrated embodiment, the fixed portion of the stiffener corresponds to an annular body 102 affixed to the hub via one or more mounting supports 116 and the rotatable portion corresponds to a plurality of gear pinions 104 configured to engage the plurality of gear teeth 80 around the inner circumference 86 of the inner race 56. More specifically, the body 102 may include a top portion 106, a bottom portion 108, and a web portion 110 extending between the top and bottom portions 106, 108. As such, any number of the gear pinions 104 may fit between the top and bottom portions 106, 108.

In various embodiments, the web portion 110 may extend generally perpendicularly between the top and bottom portions 106, 108 so as to define a generally “U” shape. In further embodiments, the web portion 110 may extend between the top and bottom portions 106, 108 so as to define a generally “C” shape. In still further embodiments, the web portion 110 may extend between the top and bottom portions 106, 108 to define any suitable shape so as to accommodate the gear pinions 104 therebetween.

In an alternative embodiment, the body 102 may include only the top and bottom portions 106, 108 (i.e. the web portion 110 may be eliminated). As such, the top and bottom portions 106, 108 may be two separate plates connected by a plurality of pins or any other suitable fastening members. For example, in one embodiment, a top plate may be separated from a bottom plate by a plurality of gear pinions 104 disposed therebetween. As such, a plurality of pins and/or fastening members may connect the plates and gear pinions together to form the stiffener 100.

Referring to FIG. 5, it should also be understood that the body 102 of the stiffener 100 may generally define a generally annular or ring shape with an open center 96. As such, the stiffener 100 may be similar in shape to the pitch bearing 52 so as to save space within the hub 18 of the wind turbine 10. Alternatively, the body 102 may have a generally solid center. In still another embodiment, as shown in FIG. 7, the stiffener 200 may include a body 202 having a stiffening web 207 extending within the open center 96. The stiffening web 207 may be formed from one or more stiffening arms 209 extending radially inwardly from the web portion 210 so as to be connected integrally at a center of the stiffener 200. Further, the stiffening arms 209 may be spaced apart from one another such that a plurality of openings 211 are defined within the stiffener 200. In yet another embodiment, the stiffening web 207 may be configured to extend radially inwardly from the web portion 210 such that a single web opening is defined in the stiffener 200 (e.g., at the center of the stiffener 200 or at any other suitable location).

In still additional embodiments, the stiffener 100, 200 may extend around a portion of the inner circumference 86 of the inner race 56 or may extend around the entire inner circumference 86 of the inner race 56. Further, the body 102, 202 of the stiffener 100, 200 may be constructed of a single segment or may be constructed of a plurality of segments. In the latter embodiment, the stiffener 100, 200 may be installed up tower of the wind turbine 10 without the use of costly cranes.

As shown in FIG. 5, an outermost diameter D₁ of the body 102 is generally smaller than an innermost diameter D₂ of the inner race of the pitch bearing 52. As such, the stiffener 100 may fit at least partially within the volume 88 defined by the inner circumference 86. More specifically, the body 102 may extend axially within at least a portion of the volume 88 defined by the inner circumference 86. Additionally, any number of gear pinions 104 may be employed in the stiffener 100. For example, in the illustrated embodiments, eleven gear pinions 104 are equally spaced around the outer periphery 112 of the body 102. Further, the gear pinions 104 may be spaced around and extend outside of an outer periphery 112 of the body 102 so as to engage the pitch bearing gear teeth 80 at multiple locations. It should be understood that in various embodiments, the number of gear pinions 104 may be a function of the size of the pitch bearing 52. In addition, the gear pinions 104 may be any suitable size and/or shape. For example, in one embodiment, the size and shape of the gear pinions 104 correspond to the size and shape of the pitch drive pinion 78 such that each pinion experiences the same load from the pitch bearing 52.

Referring now to FIG. 6, the body 102 may also include an opening 114 configured to receive the pitch adjustment mechanism 72. The opening 114 is typically located in the bottom portion 108 of the body 102 (i.e. the hub-side portion of the stiffener 100). By providing an opening 114 in only the bottom portion 108 of the body 102, the stiffener 100 maintains more uniform stiffness throughout the body 102. In alternative embodiments, the opening 144 may extend through both the top and bottom portions 106, 108 of the body 102.

It should also be appreciated that the stiffener 100 may be coupled to the wind turbine 10 using any suitable means. For example, as shown in various illustrated embodiment, the stiffener 100 is coupled to the hub 18 via one or more mounting supports 116. Further, the mounting supports 116 may be coupled between the body 102 and the hub 18 using any suitable means. For example, in one embodiment, the mounting support may be secured to the body 102 by welding and may be secured to the hub 18 using a mechanical fastener 120 (as shown), or vice versa.

In addition, the mounting supports 116 may correspond to mounting brackets spaced circumferentially about the outer periphery 112 of the bottom portion 108 of the body 102. For example, as shown in FIG. 6, at least three mounting brackets are illustrated and spaced evenly about the outer periphery 112 of the bottom portion 108. Alternatively, the mounting brackets may be spaced randomly about the outer periphery 112 of the body 102. In a further embodiment, more than three or less than three mounting brackets may be utilized to mount the body 102 to the hub 18.

The mounting supports 116 may be any suitable shape and/or material so as to couple the stiffener 100 to the hub 18. As such, the mounting supports 116 may secure the body 102 to the hub 18 such that the body 102 remains fixed relative to the inner race 56, while the gear pinions 104 may freely rotate along with the inner race 56. For example, in one embodiment, the mounting supports 116 may be a relatively rigid material, such as metal. In one particular embodiment, the mounting supports 116 are made of steel. Further, in another embodiment, the mounting supports 16 may be shaped so as to correspond to the shape of the body 102 of the stiffener 100, the inner race 56, and the hub flange 60.

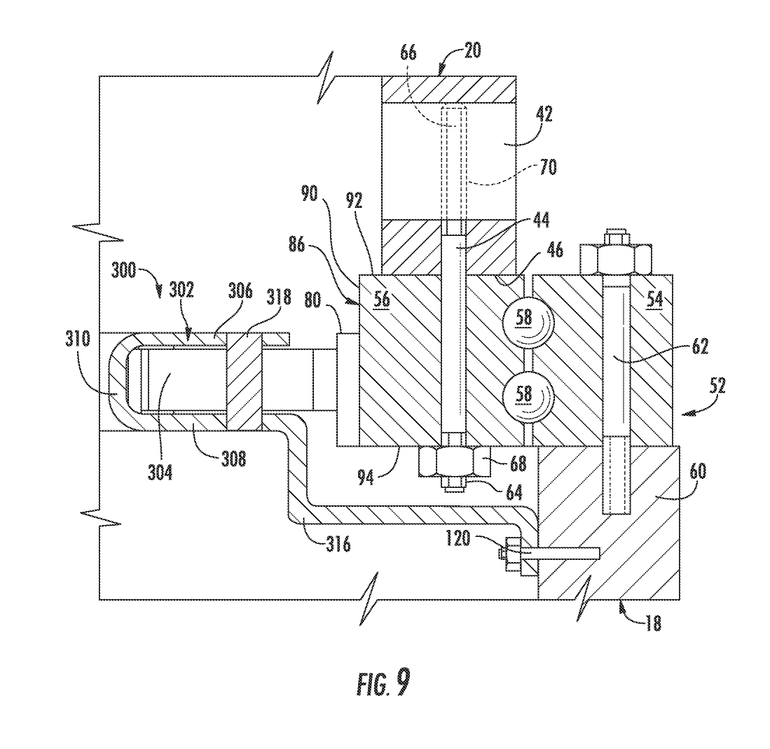

In an alternative embodiment, as shown in FIG. 9, stiffener 300 is illustrated having a top portion 318, a bottom portion 308, and a web portion 310. Further, the stiffener 300 has at least one mounting support that corresponds to a mounting flange 316. As illustrated, the mounting support is formed integrally with the bottom portion 308 of the body 302 such that the stiffener 300 and the mounting support are a single component. In such an embodiment, the stiffener 300 may include one or more than one mounting flange 316 spaced circumferentially about the outer periphery of the body 302, similar to the mounting brackets described above.

It should also be appreciated that the stiffener and all of the stiffener components as described herein may be constructed of any suitable material to provide the appropriate stiffness to the pitch bearing. For example, in one embodiment, the stiffener and the various components that make up the stiffener (e.g. the body and the gear pinions) is constructed of steel. In further embodiments, the stiffener and/or the various components that make up the stiffener may be constructed of any other suitable metal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A pitch bearing assembly for a wind turbine, the pitch bearing assembly comprising:
an outer race;
an inner race rotatable relative to the outer race, the inner race defining an inner circumference, the inner race comprising a plurality of gear teeth around the inner circumference; and,
a stiffener comprising a body and at least one gear pinion, the body extending at least partially around the inner circumference of the inner race, the at least one gear pinion being configured so as to engage a portion of the plurality of gear teeth.

2. The pitch bearing assembly of claim 1, wherein the inner circumference defines a volume within the inner race, the body extending axially within at least a portion of the volume defined by the inner circumference.

3. The pitch bearing assembly of claim 1, wherein the body is ring-shaped and extends around the entire inner circumference of the inner race.

4. The pitch bearing assembly of claim 3, wherein the body comprises an opening configured to receive a pitch drive pinion of a pitch adjustment mechanism.

5. The pitch bearing assembly of claim 1, wherein the body includes a top portion, a bottom portion, and a web portion extending between the top and bottom portions.

6. The pitch bearing assembly of claim 5, further comprising a plurality of gear pinions spaced circumferentially about an outer periphery of the body between the top and bottom portions.

7. The pitch bearing assembly of claim 6, wherein a portion of each of the plurality of gear pinions extends outside the outer periphery of the body of the stiffener.

8. The pitch bearing assembly of claim 5, wherein the web portion extends substantially perpendicularly between the top and bottom portions so as to define a generally “U” shape.

9. The pitch bearing assembly of claim 1, wherein the stiffener further comprises at least one mounting support configured to mount the body to a hub.

10. The pitch bearing assembly of claim 9, wherein the at least one mounting support corresponds to a plurality of mounting brackets spaced circumferentially about the body.

11. The pitch bearing assembly of claim 6, wherein the plurality of gear pinions and a pitch drive pinion have substantially equal diameters.

12. A pitch bearing assembly for a wind turbine, the pitch bearing assembly comprising:
an outer race;
an inner race rotatable relative to the outer race, the inner race defining an inner circumference, the inner circumference defining a volume within the inner race, the inner race comprising a plurality of gear teeth around the inner circumference; and,
a stiffener disposed within the volume, the stiffener comprising a fixed portion and a rotatable portion, the fixed portion configured to attach to the hub, the rotatable portion configured to accommodate rotation of the inner race.

13. A rotor blade assembly for a wind turbine, comprising:
a rotor blade including a body shell extending between a blade root and a blade tip;
a pitch bearing coupled to the blade root, the pitch bearing including an outer race and an inner race rotatable relative to the outer race, the inner race defining an inner circumference and including a plurality of gear teeth around the inner circumference; and,
a stiffener comprising a body and at least one gear pinion, the body extending at least partially around the inner circumference, the at least one gear pinion engaging a portion of the plurality of gear teeth,
wherein the rotor blade is configured to couple to the pitch bearing, and wherein the pitch bearing is configured to couple to a hub of the wind turbine.

14. The rotor blade assembly of claim 13, wherein the body is fixed relative to the hub when the pitch bearing is coupled to the hub.

15. The rotor blade assembly of claim 13, wherein the body includes a top portion, a bottom portion, and a web portion extending between the top and bottom portions.

16. The rotor blade assembly of claim 15, further comprising a plurality of gear pinions, the plurality of gear pinions spaced circumferentially about an outer periphery of the body between the top and bottom portions.

17. The rotor blade assembly of claim 16, wherein a portion of each of the plurality of gear pinions extends outside the outer periphery of the body of the stiffener such that the plurality of gear pinions rotate along the plurality of gear teeth when the pitch bearing is coupled to the hub.

18. The rotor blade assembly of claim 13, wherein the inner circumference defines a volume within the inner race, the body extending axially within at least a portion of the volume defined by the inner circumference.

19. The rotor blade assembly of claim 13, wherein the body is ring-shaped and extends around the entire inner circumference of the inner race, the body comprising an opening configured to receive a pitch adjustment mechanism.

20. The rotor blade assembly of claim 13, wherein the stiffener further comprises at least one mounting support configured to mount the stiffener to the hub.
